(19) United States
(12) Patent Application Publication
(10) Pub. No.: US 2009/0177986 A1
(43) Pub. Date: Jul. 9, 2009

(54) THIRD PARTY IN-PAGE APPLICATION PLATFORM

(75) Inventors: Christopher Lee Butler, San Francisco, CA (US); Jose Martin, Danville, CA (US); Syed Muneeb-ul-Haq, San Jose, CA (US); Mikhail Birman, San Francisco, CA (US); James Robert Egan, Sunnyvale, CA (US); Junaid Basir, Palo Alto, CA (US)

Correspondence Address: SENNIGER POWERS LLP (MSFT), 100 NORTH BROADWAY, 17TH FLOOR, ST. LOUIS, MO, 63102, US

(73) Assignee: MICROSOFT CORPORATION, Redmond, WA (US)

(21) Appl. No.: 11/970,182

(22) Filed: Jan. 7, 2008

(51) Int. Cl. G06F 3/048; G06F 15/16

(52) U.S. Cl. 715/764; 709/203

(57) ABSTRACT

Managing interactions between a user and an interactive application within an online interactive page. A selected interactive application is received from a user. The selected interactive application is transmitted from a host server to a remote partner server. Interactive controls of the selected interactive application are received from the remote partner server in response to the transmitting. Resulting controls are appended to the interactive controls. The received interactive controls and the appended resulting controls are provided to the user via the online interactive page. The user interacts with the particular interactive application through the interactive controls and the appended resulting controls to customize a media object. The customized media object is received from the remote partner server. The customized media object is stored on the user's local device.

### BACKGROUND

The omnipresence of high speed internet connections enables users to engage increased commercial activities over the Internet. Merchants and retailers constantly provide new and advanced features on their online interfaces or web pages to provide not just contents but also interactions. One area of web interactions is a creation of a personalized virtual model for online apparel shoppers. For example, an online retailer enables a user to create and customize a virtual model by enabling the user to put on various outfits or merchandizes on the virtual model. This virtual model attempts to give the user a shopping experience as if the user is actually trying on the outfits. Other interactions also include customize a provider's content, such as dynamic display pictures, winks, gadgets, etc.

While these customizations (e.g., virtual models) are very useful to the user, these customizations do not stay with the user for other uses. In other words, if the user creates the virtual model for shopping at a first online retailer, the user either needs to customize another virtual model, if provided, at a second online retailer or needs to shop at the second online retailer without the virtual model. Therefore, the user is left with disappointment and may need to customize a separate virtual model for each online retailer. As such, the user is left with inconsistent user experience and needs to perform redundant activities for the same act with different retailers or content providers.

### SUMMARY

Aspects of the invention provide a platform for providing users with rich online user experience by enabling a third party or a partner to provide an in-page application on a given web page such that the user is able to store customized content created from the in-page application on the user's local device for later usage. Embodiments of the invention provide or append controls within the in-page application so that, upon completion of the customization, embodiments of the invention enable storing of the customized content or object. Alternative embodiments of the invention may also link with accounting options before storing the object, such as pricing of the customized content or object, etc. Furthermore, embodiments of the invention enable the third party or partner to maintain full control of the in-page application so as to promote ease of management of the content and provide efficiency in maintaining the in-page application.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary embodiment of a diagram illustrating a system for managing interactions between a user and an interactive application with an online interactive page according to an embodiment of the invention.

FIGS. 2 to 7 are exemplary screen displays illustrating interactions between a user and an interactive application according to an embodiment of the invention.

FIG. 8 is an exemplary flow chart illustrating operation of managing interactions between a user and an interactive application with an online interactive page according to an embodiment of the invention.

Corresponding reference characters indicate corresponding parts throughout the drawings.

### DETAILED DESCRIPTION

Aspects of the invention establish a robust platform for working with partners in an internet environment in managing interactions between a user and an interactive application provided by the partner. Embodiments of the invention enable the users to be able to store customized content or object, created from the interactive application, on the user's local device so that the user may use the customized content or object in other applications or settings.

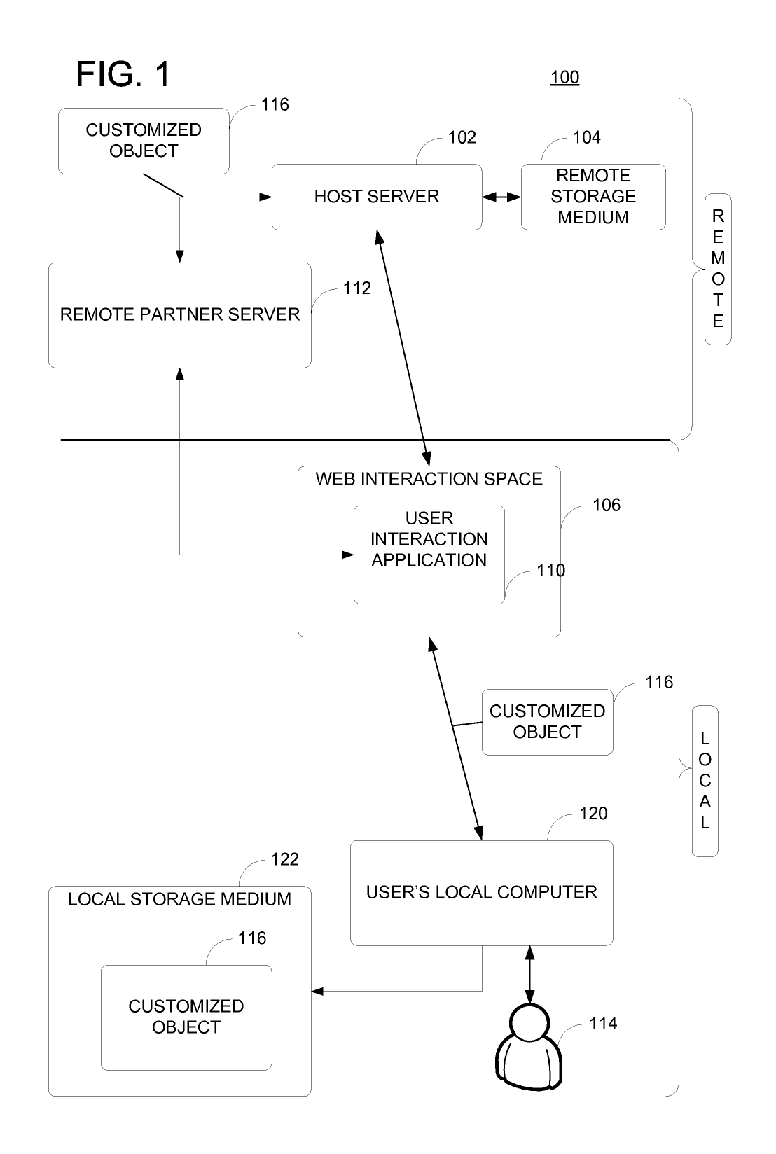

Referring now to FIG. 1, a diagram illustrates a system 100 for managing interactions between a user and an interactive application with an online interactive page according to an embodiment of the invention. The system 100 includes a host server 102 which includes one or more processors, microprocessors, or processing units. The host server 102 is also accessible to a remote storage medium 104 for storing, among other things, data associated with the host server 102. In one embodiment, the host server 102 is a collection of server computers that includes an authentication server, a web server, a database server, front end servers, and the like. For example, the host server 102 may be part of an enterprise service that provides various types of services to users, such as news services, online search services, directory services, communication services (e.g., electronic mail (e-mail) accounts, instant messaging services), local map or positioning services, and the like. In another example, the host server 102 may provide a web interactive space 106, such as a web portal, online interactive page, or a web page filled with components (e.g., modules or web widgets) that provide content to the user. In this example, the web interactive space 106 includes one or more user-personalized content (e.g., local news, local weather, or the like) and one or more interactive services provided through the host server 102. Such interactive services include a user interactive application (UIA) 110, and the user interactive application 110 is controlled, managed or maintained by a remote partner server 112.

For example, the remote partner server 112 may be an online merchant or retailer for selling various merchandizes to an online user 114. For example, the remote partner server 112 may be a company that creates customizable graphical objects to users, such as emoticon or other graphics. As such, the remote partner server 112 provides the UIA 110 with interactive controls for the UIA 110 to the web interactive space 106 for the user 114.

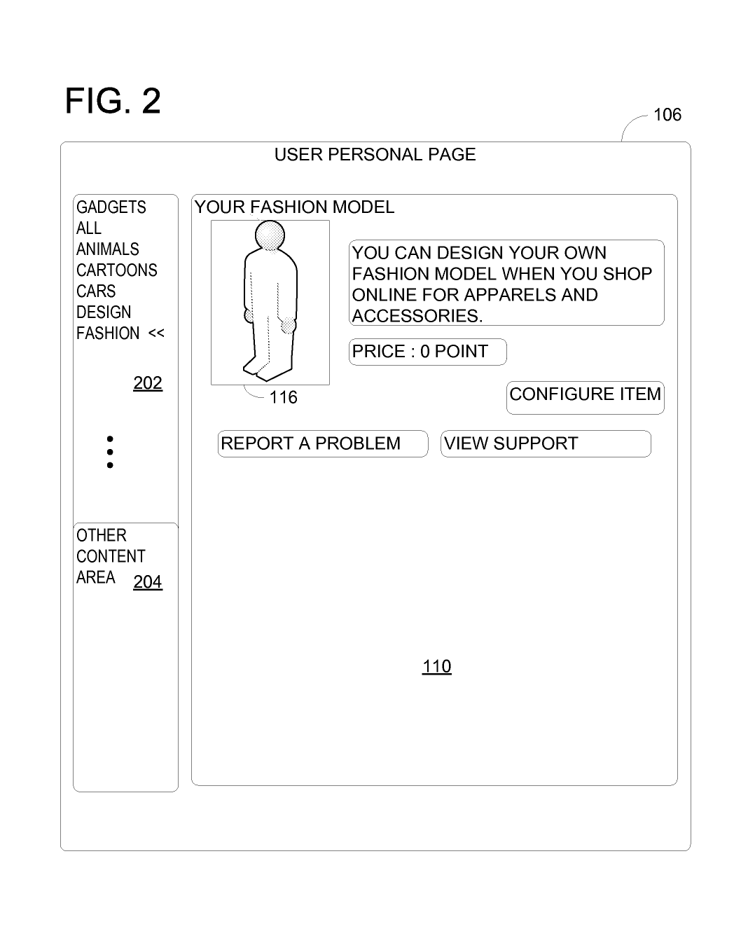

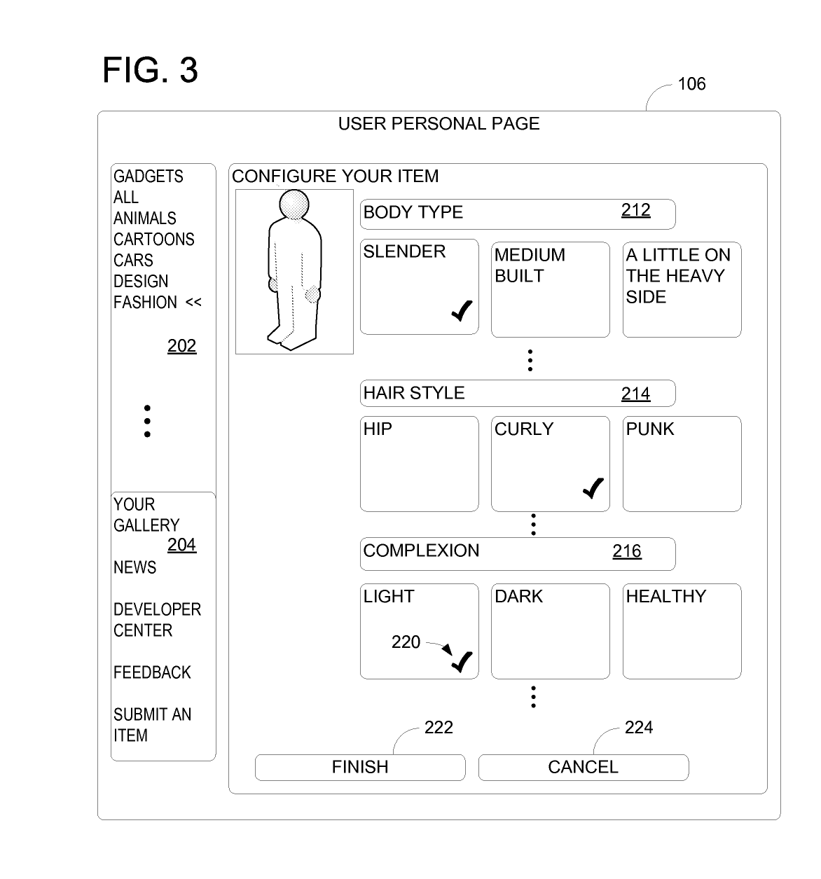

To further illustrate aspects of the invention, FIGS. 3 to 7 show screen displays illustrating interactions between a user and an interactive application according to an embodiment of the invention. In FIG. 2, a screen display shows an exemplary web interactive space 106. In this example, the web interactive space 106 shows a user's personal page over the internet. The web interactive space 106 shows a left pane 202 having a collection of one or more interactive applications available for the user 114. For example, the left pane 202 shows one or more “GADGETS”, such as “ALL,” “ANIMALS,” “CARTOONS,” “CARS,” “DESIGN,” and “FASHION.” It is to be understood other gadget types or categories may be used, or other gadgets may be provided without departing from the scope or spirit of the invention. In this example, the user 114 selects the “FASHION” gadget, and the selection is received by the host server 102, and the host server 102 transmits the selection to the remote partner server 112.

In one embodiment, upon selecting the gadgets in the left pane 202, parameters specified by the host server 102 are embedded in the selection when the selection is sent to the remote partner server 112. The remote partner server 112 returns a hypertext markup language (HTML) uniform resource locator (URL) containing the customization or interactive controls (to be further discussed below) that would be used to customize an item. In this example, the host server 102 calls or requests the URL. In an alternative embodiment, before making the call, the host server 102 appends or inserts additional information the URL for the remote partner server 112. In one example, the additional information that is appended includes the following:

1. Market. This tells the partner what language to show the wizard control in.

2. Session Id for this particular customization user session. Partner can use this to uniquely track a user session for a particular customizable item.

3. Finish or completion URL. Partner will use this URL to construct the call to the host server 102 if the user clicks “Finish” in the customization wizard control.

4. Cancel or cancellation URL. Partner will use this URL to construct the call to the host server 102 if the user clicks “Cancel” in the customization wizard control

The web interactive space 106 may further include a lower pane 204 showing one or more other content area provided by the web interactive space 106. For example, the web interactive space 106 includes a page or space for the user's photos, news content, information for software developers, feedback to the host server 102, or the like. Other content may be provided and/or included in the lower pane 204 without departing from the scope or spirit of the invention.

Upon receiving the selection, the remote partner server 112 transmits the UIA 110 to the host server 102 and the host server 102 receives the UIA 110 from the remote partner server 112 before providing the UIA 110 to the user 114. In this example, the UIA 110 is an application or program for customizing or creating a personal fashion model for the user 114. In one embodiment, the UIA 110 may be computer-executable instructions written in dynamic hypertext markup language (DHTML), Adobe® Flash, asynchronous JavaScript and extensible markup language (XML) (AJAX), or JavaScript® programming languages. In another example, the other languages or programming techniques may be used in implementing and providing interactive aspects to the user 114.

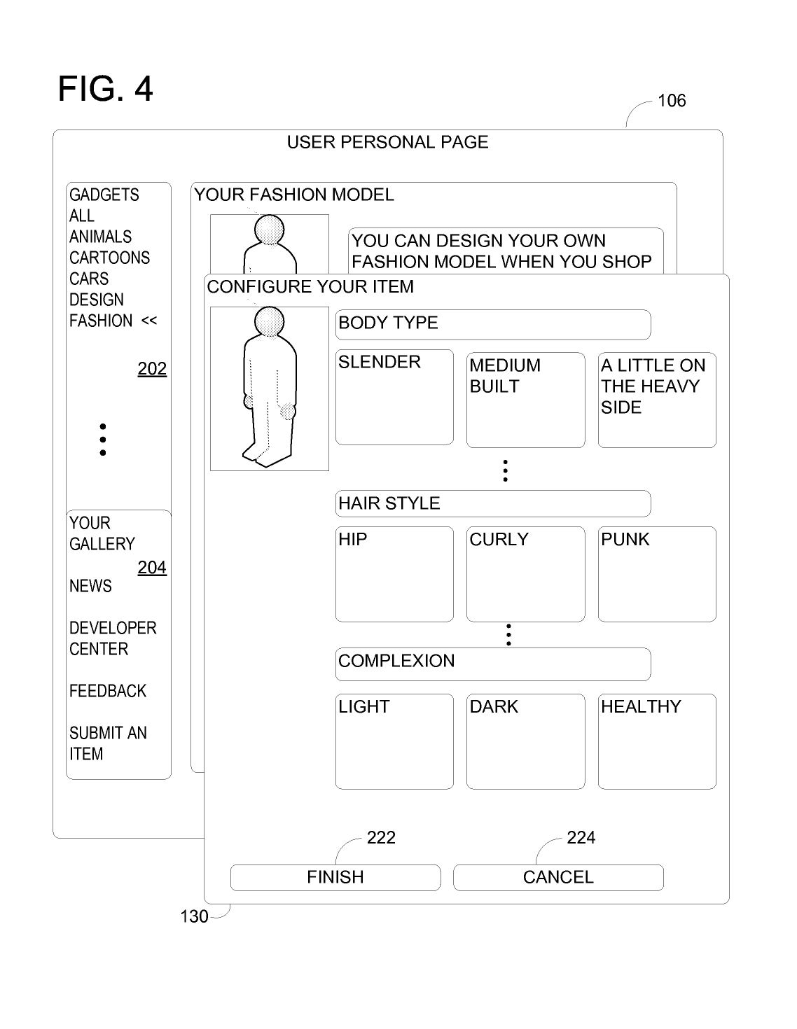

In one embodiment, an HTML is sent in response to the call to the URL for the UIA 110. The HTML content of the UIA 110 is shown inline in an IFRAME within the web interactive page 106 to the user 114. In this example, in the IFRAME implementation, the user's location computer 120 or an application, such as an internet browser, will combine the UIA 110 and the data associated with the UIA 110 on the user's local computer 120 rather than having the host server 102 and/or remote partner server 112 providing run-time data for executing the UIA 110. In another embodiment, a separate window or a pop-up window, such as window 230 may be provided instead of the in-page rendering of the UIA 110, as shown in FIG. 4. In another embodiment, the HTML content is the UIA 110 that includes interactive controls described below.

In one example and as shown in FIG. 2, the UIA 110 provides a customizable object 116 for customization. In one embodiment, the customizable or customized object 116 may be an file, personalized object, or an object having one or more of the following: an image, a graphical composition, a graphical animation, a set of computer-executable instructions, a flash file or object, a video file, an object container including action or executable script, or the like. In this example, a sample virtual fashion model 116 to the user 114 and provides a control, “CONFIGURE ITEM,” to the user 114 for configuring or customizing the virtual fashion model 116. Other controls, such as “REPORT A PROBLEM” or “VIEW SUPPORT,” are provided for requesting assistance from the remote partner server 112.

In one embodiment, the remote partner server 112 maintains full control of the behaviors of the UIA 110. In other words, the remote partner server 112 controls the activities of the UIA 110 and has direct links and management of the UIA 110.

Referring now to FIG. 2, once the user 114 activates the control “CONFIGURE ITEM,” the UIA 110 activates additional interactive controls for further interaction with the user 114. For example, the interactive controls include controls 212 for customizing a body type of the virtual fashion model 116, controls 214 for customizing a hair style of the virtual fashion model 116, and controls 216 for customizing complexion of the virtual fashion model 116. A check mark 220 indicates the user's selection of the different controls of the UIA 110. Other controls may be provided depending on the type of applications the remote partner server 112 wishes to provide. In other words, the remote partner server 112 has a full range of control and management of the UIA 110. Aspects of the invention let the partners own the customization experience within the UIA 110 which includes but is not limited to building the wizard control but make it possible for the bits to be available to the user 114 of the host server 102.

Still referring to FIG. 3, the UIA 110 also includes two additional controls: a completion control 222 and a cancellation control 224. In one embodiment, the remote partner server 112 provides these two controls to the UIA 110 among the other interactive controls. In another embodiment, the completion control 222 and the cancellation control 224 may be appended to the UIA 110 by the host server 102. In yet another embodiment, once the user 114 actives the completion control 222, the remote partner server 112 receives such activation and generates the appropriate cabbed file per end user customization. In the example of FIG. 3, a cabbed file of the virtual fashion model customized by the user 114 is generated. In one embodiment, the remote partner server 112 notifies the host server 102 a location where the file is stored. For instance, upon activation of the completion control or the “FINISH” button 222, the remote partner server 112 constructs a URL based on the finish URL they received from the user 114 (after activating the completion control 222). In one implementation, the remote partner server 112 includes the location information where the remote partner server 112 stored the file and a partner key that is unique for each partner to the host server 102.

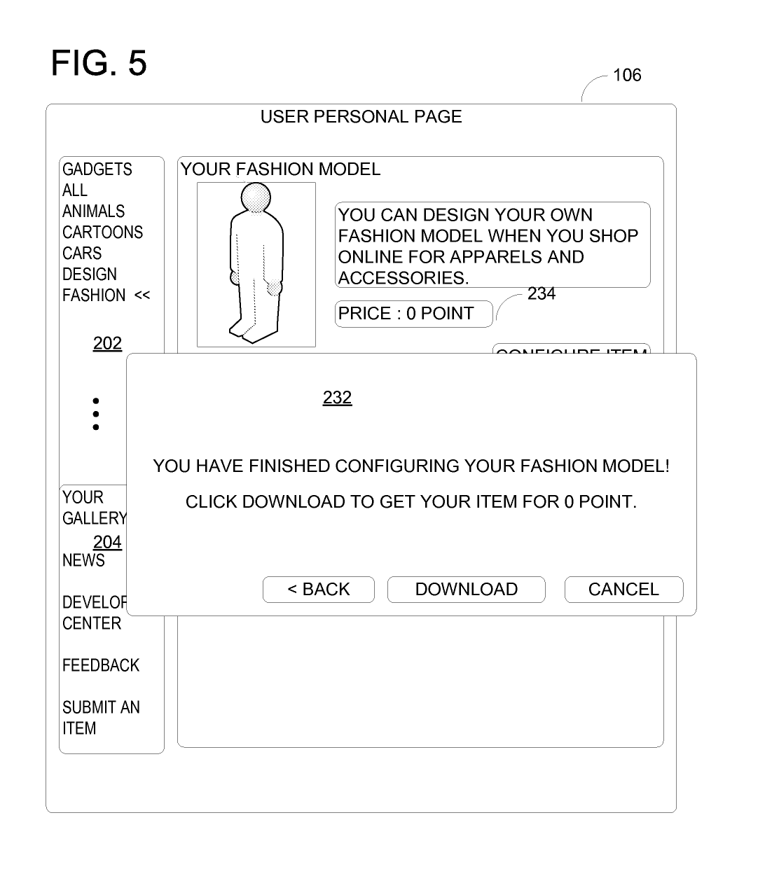

Referring now to FIG. 5, upon receiving the location information of the file containing the customized object, the host server 102 provides a window 232 confirming with the user 114 whether the user wishes to store the customized object on a user's local storage medium 122 accessible by a user's local device or computer 120. For example, the host server 102 retrieves the file with the customized object 116 and may first stores it at the remote storage medium 104. In one embodiment, additional dialogue windows may be provided by the host server 102 to the user 114 for additional interactions after the user 114 activates the completion control 222. For example, the customized object 116 may include pricing information 234 associated therewith. As such, upon completion of the customization through the interactive controls, the host server 102 and/or the remote partner server 112 may associate the customized object 116 with appropriate pricing conditions or limitations to the object 116 before the user 114 may store it on the local device 120.

On the other hand, if the user 114 wishes to cancel the customization by activating the cancellation control 224 or the “CANCEL” button, such activation is received by the remote partner server 112. The remote partner server 112 may construct another URL based on the cancel button or cancellation control 224 and a partner key that is unique for each partner. The host server 102 receives such URL and partner key and may redirect the user 114 to a different location. For example, upon cancellation, the web interactive space 106 may display a different content, activates another window showing or the like to direct the user 114.

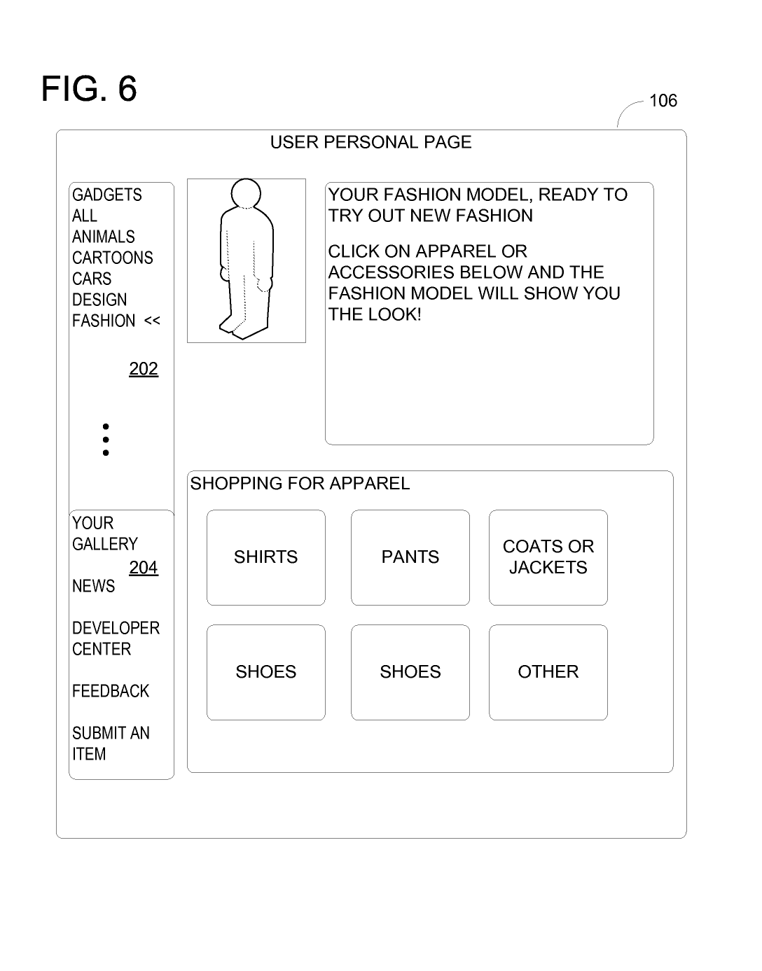

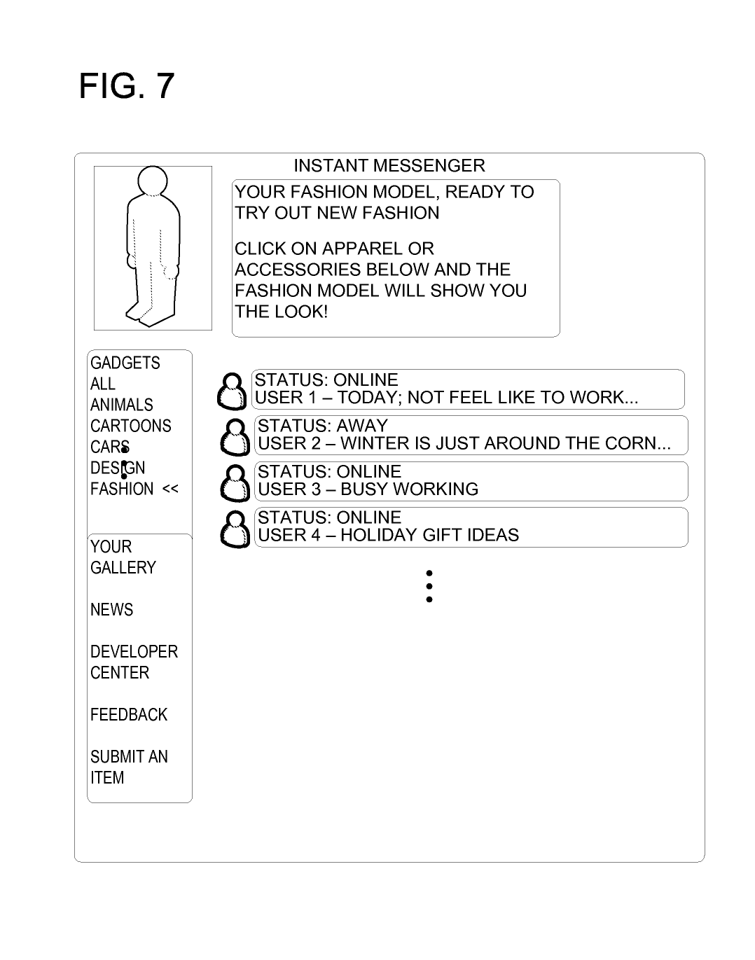

With the customized object 116, the user 114 may apply the customized object 116 to any other applications or files locally. For example, the user 114 may use the customized object 116 in an online shopping web site, as shown in FIG. 6. As another example, the user 114 may apply the customized object 116 as a graphics for an application, such as an instant messenger application in FIG. 7.

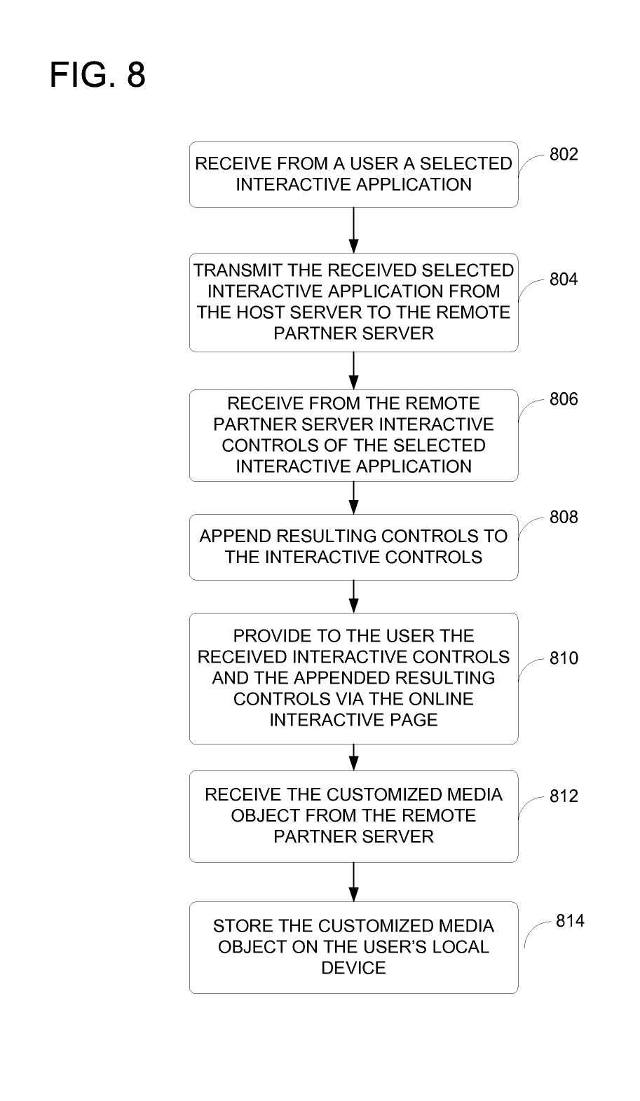

Referring now to FIG. 8, an exemplary flow chart illustrating operation of managing interactions between a user and an interactive application with an online interactive page according to an embodiment of the invention. Initially, a host server hosts an online interactive page and a remote partner server provides an interactive application to be provided within the online interactive page for the user. At 802, the host server (e.g., host server 102) receives from the user a selected interactive application (e.g., UIA 110). The host server 102 transmits the received selected interactive application to the remote partner server at 804. Interactive controls of the selected interactive application are received from the remote partner server (e.g., remote partner server 112) in response to the host server 102 transmitting the selected interactive application at 806. At 608, the host server 102 appends resulting controls to the interactive controls. In one embodiment, the remote partner server 112 provides graphical controls for the resulting controls while the host server 102 appends parameters associated with the resulting controls.

At 810, the host server 102 provides to the user the received interactive controls and the appended resulting controls via the online interactive page (e.g., web interactive space 106). The user interacts with the particular interactive application through the interactive controls and the appended resulting controls to customize a media object (e.g., customized object 116). At 812, the host server 102 receives the customized media object from the remote partner server. The customized object 116 is stored on the user's local device at 814.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A method of managing interactions between a user and an interactive application within an online interactive page, wherein the interactive application is managed by a remote partner server, wherein the online interactive page is hosted by a host server, and wherein the user has a local device which is remote with respect to the host server and the remote partner server, said method comprising:
receiving from the user a selected interactive application;
transmitting the received selected interactive application from the host server to the remote partner server;
receiving from the remote partner server interactive controls of the selected interactive application in response to the transmitting;
appending resulting controls to the interactive controls;
providing to the user the received interactive controls and the appended resulting controls via the online interactive page, wherein the user interacts with the particular interactive application through the interactive controls and the appended resulting controls to customize a media object;
receiving the customized media object from the remote partner server; and
storing the customized media object on the user's local device.

2. The method of claim 1, wherein transmitting comprises transmitting a partner identification associated with the remote partner server and the particular interactive application along with the received selection, wherein said remote partner server adapted to execute the particular interactive application.

3. The method of claim 1, further comprising providing a user interface (UI) to the user after receiving the customized media object from the remote partner server, and further comprising receiving an instruction via the UI from the user for storing the customized media object on the local device.

4. The method of claim 3, wherein providing the UI comprises providing the UI to the user for applying the customizable media object to another services provided by the host server.

5. The method of claim 1, wherein the media object comprises at least one or more of the following: an image, a graphical composition, a graphical animation, a set of computer-executable instructions, and a video file.

6. The method of claim 1, wherein the resulting controls comprises a completion control and a cancellation control, said completion control generating a uniform resource location (URL) indicating a location storing the customized media object by the remote partner server, and further comprising sending the generated URL from the remote partner server to the host server.

7. The method of claim 6, further comprising generating a second URL in response to an activation of the cancellation control by the user, said second URL directing the host server to a separate location independent of a location of the interactive application.

8. The method of claim 1, wherein providing comprises providing the received interactive controls and the appended resulting controls to the user in one or more of the following: a separate pop-up window or inline with the online interactive page.

9. A method of managing interactions between a user and an interactive application within an online interactive page, wherein the interactive application is managed by a remote partner server, wherein the online interactive page is hosted by a host server, and wherein the user has access to a local device which is remote with respect to the host server and the remote partner server, said method comprising:
receiving from the user a selected interactive application;
transmitting the received selected application from the host server to the remote partner server;
receiving from the remote partner server interactive controls of the selected interactive application in response to the transmitting, said interactive controls including one or more graphical elements for editing a personalized object;
inserting resulting controls provided by the host server into the interactive controls;
providing to the user the received interactive controls and the inserted resulting controls via the online interactive page, wherein the user interacts with the particular interactive application through the interactive controls and the inserted resulting controls to customize the personalized object;
receiving the customized personalized object from the remote partner server;
providing a user interface (UI) to the user in response to the received customized personalized object; and
receiving from the user an instruction via the provided UI for storing the customized personalized object on the user's local device.

10. The method of claim 9, wherein transmitting comprises transmitting a partner identification associated with the remote partner server and the particular interactive application along with the received selection, wherein said remote partner server adapted to execute the particular interactive application.

11. The method of claim 9, further comprising providing a user interface (UI) to the user after receiving the customized personalized object from the remote partner server, and further comprising receiving an instruction via the UI from the user for storing the customized personalized object on the local device.

12. The method of claim 11, wherein providing the UI comprises providing the UI to the user for applying the customizable personalized object to another services provided by the host server.

13. The method of claim 9, wherein the resulting controls comprises a completion control and a cancellation control, said completion control generating a uniform resource location (URL) indicating a location storing the customized personalized object by the remote partner server, and further comprising sending the generated URL from the remote partner server to the host server.

14. The method of claim 13, further comprising generating a second URL in response to an activation of the cancellation control by the user, said second URL directing the host server to a separate location independent of a location of the interactive application.

15. The method of claim 9, wherein providing comprises providing the received interactive controls and the appended resulting controls to the user in one or more of the following: a separate pop-up window or inline with the online interactive page.

16. A system of managing interactions between a user and an interactive application within an online interactive page, said system comprising:
a host server for hosting the online interactive page;
a remote partner server for managing the interactive application;
a local device accessible by the user, wherein the local device is remote with respect to the host server and the remote partner server;
wherein the host server receives from the user a selected interactive application provided by the remote partner server;
wherein the host server transmits the received selected application to the remote partner server;
wherein the host server receives from the remote partner server interactive controls of the selected interactive application, said interactive controls including one or more graphical elements for editing a media object;
wherein the host server inserts resulting controls into the interactive controls;
wherein the host server provides to the user the received interactive controls and the inserted resulting controls via the online interactive page, wherein the user interacts with the particular interactive application through the interactive controls and the inserted resulting controls to customize the media object;
wherein the host server receives the customized media object from the remote partner server;
wherein the host server provides a user interface (UI) to the user in response to the received customized media object; and
wherein the host server receives from the user an instruction via the provided UI for storing the customized media object on the user's local device.

17. The system of claim 16, wherein the host server transmits a partner identification associated with the remote partner server and the particular interactive application along with the received selection, wherein said remote partner server adapted to execute the particular interactive application.

18. The system of claim 16, wherein the host server is further configured to provide the user pricing information associated with the customized media object before receiving the instruction from the user for storing the customized media object on the user's local device.

19. The system of claim 16, wherein the resulting controls comprises a completion control and a cancellation control, and wherein the remote partner server generates a uniform resource location (URL) indicating a location storing the customized media object by the remote partner server, and further sends the generated URL to the host server.

20. The system of claim 17, wherein the remote partner server is configured to generate a second URL in response to an activation of the cancellation control by the user, said second URL directing the host server to a separate location independent of a location of the interactive application.
